(19) United States
(12) Patent Application Publication
(10) Pub. No.: US 2006/0083888 A1
(43) Pub. Date: Apr. 20, 2006

(54) System and method for handling, organizing and storing mats

(76) Inventors: Terry Downes, Christmas Commom (GB); Michael Edwards, Christmas Common (GB); Andrew Gilkes, Christmas Common (GB); Ian Malpass, Alpharetta, GA (US)

Correspondence Address: KING & SPALDING LLP, 191 PEACHTREE STREET, N.E., 45TH FLOOR, ATLANTA, GA, 30303-1763, US

(21) Appl. No.: 11/242,634

(22) Filed: Oct. 3, 2005

Related U.S. Application Data
(60) Provisional application No. 60/615,403, filed on Oct. 1, 2004.

(51) Int. Cl. B32B 3/00

(52) U.S. Cl. 428/53

(57) ABSTRACT

A system for handling, organizing and storing floor mats includes a loading station and control center. The loading station can include a radio frequency identification device (RFID). The elevator RFID may communicate with the control center. The loading station may be connected to an elevator. The elevator may lift the mat to a primary collector conveyor. The control center may cause the mat to be moved to an organizer carousel wherein mats are stored, based on a set organization method. The control center may initiate the mats to be removed from the organizer carousel and moved to the off-going transfer conveyor, where the mats may then be rolled. The organizing and storing method of the system alleviates inefficiency of conventional handling, organizing and storing techniques.

### RELATED APPLICATION

The present application claims priority under 35 U.S.C. § 119(e) based upon U.S. Provisional Patent Application No. 60/615,403 entitled, “System and Method for Handling, Organizing and Storing Mats,” filed on Oct. 1, 2004. The complete disclosure of the above-identified priority application is hereby fully incorporated by reference.

### FIELD OF THE INVENTION

The invention relates generally to the handling, organizing, drying and storing of planar objects of various sizes. More particularly, the invention relates to a system and method whereby planar objects such as floor mats can be easily stored and organized for prompt storage or shipment.

### BACKGROUND OF THE INVENTION

Cleaning floor mats typically includes several steps: retrieving floor mats from a customer, cleaning the floor mats, and returning the floor mats to the customer. Due to the reasons below, conventional floor mat cleaning techniques are logistically problematic, time-consuming and highly energy inefficient.

Foremost, conventional floor mat cleaning techniques are often time-consuming and highly energy inefficient. Usually, a floor mat is washed using hot water and chemicals. After washing, the mat is typically dried with large heaters powered by electricity that use steam or gas. While current drying techniques can dry wet mats, the amount of heat required to evaporate water and other cleaning liquids from a wet mat can be very large and thus expensive.

After a mat is cleaned and dried, it is typically rolled for storage and shipment. This process of rolling mats, if done manually, can be a very time consuming process. Additionally, mats are often organized after being cleaned and rolled, making for a very time-consuming and cumbersome task due to the size and shape of the rolled mats. Further, when a mat is rolled and stored according to conventional techniques it occupies a large amount of storage space. Thus, large volumes of space are often required to store the floor mats after they have been cleaned.

Besides occupying large amounts of space, rolled mats are also not easily identifiable. This can create a logistical problem for organizing and storing them. One conventional remedy is to tag a mat once it is cleaned and rolled. This allows the rolled mat to be grouped and stored according to the identification tag. However, at least two problems exist with this technique. First, the mats usually must still be manually organized and stored. As mentioned previously, mats are often not organized until after they are rolled, therefore, this process becomes very time-consuming and cumbersome due to the rolled mats' bulky size and shape.

Second, if the identification tag becomes detached, the mat likely will be incorrectly organized, stored or shipped. This is because a rolled mat is not easily identifiable. Therefore, mats whose tags have become detached may need to be unrolled, re-identified and re-rolled. This can significantly add to the time needed to identify a mat. Thus, the conventional techniques are highly inefficient, leading to an excessive waste of time spent in manually identifying, storing and shipping cleaned mats.

To further stress this point, it should be noted that the problems cited above are further complicated when floor mats are unique to individual customers. For example, in some situations, each customer may have a customized local logo, trademark emblem or text, or combination thereof, embedded in or on part of a mat. If a floor mat contains one of these special emblems, logos, etc., it becomes critical that the floor mat be properly identified during the cleaning process so that it may be returned to the correct customer. Typically, sorting customized floor mats originating from different business entities is done manually. Justifiably, this process can be very tedious and time-consuming.

Thus, there presently exists in the art a need for handling, tagging and organizing floor mats in a more efficient manner. Additionally, a need in the art presently exists for a less time-consuming and more energy-efficient system for drying mats. There also exists a need in the art for a more efficient way to organize and store floor mats after they have been cleaned. Further, there exists a need in the art for a better way of identifying mats that are cleaned. Accordingly, for the above-identified reasons, as well as others not discussed, there currently exists a need in the art for a more efficient way of drying, rolling, handling, organizing and storing mats.

### SUMMARY OF THE INVENTION

The inventive system is capable of handling, organizing, drying and storing different types of planar objects, including, but not limited to, floor mats of different shapes and sizes. Specifically, the system is capable of handling and drying cleaned floor mats by loading the floor mats onto a primary organizing carousel that receives commands from a control center, thereby facilitating proper organization of the mats. Further, the system is capable of preparing mats for shipment or secondary storage.

In one embodiment of the exemplary system, a mat may be placed on the loading station to be organized or stored. The mat may be fitted before or during loading with an identification tag that can be traced by the control center. One exemplary embodiment of this tag can be a radio frequency identification device (RFID), which may be passive or active. In this exemplary embodiment, the control center may also contain a communication device that allows it to monitor the information contained on the mat's RFID. Utilizing this exemplary method allows for the control center to analyze each mat's specific RFID, thus allowing the control center to properly organize the mats on the carousel.

After being placed upon the loading station, the mat may be attached to a hanging device to facilitate organization. One exemplary embodiment of the hanging device is a t-shaped clamping device which may secure the mat by clamping portions and clamping mechanisms. In turn, the t-shaped clamping device may be connected to the various chains and conveyors that may be utilized in the system. In one exemplary embodiment, the hanging device is capable of attaching to an elevator. The elevator, in turn, may lift the mat (via the hanging device) to a primary mat accumulator.

From this point, the mat may be transferred to an organizer conveyor via a transfer conveyor. According to the exemplary system, this transfer to the organizer conveyor may be facilitated by the control center. In this exemplary embodiment, the organizer conveyor is positioned by the control center so that mats may be organized and grouped for drying or storing. Once the organizer conveyor is pre-positioned by the control center, the mat may be transferred from the primary accumulator to the organizer conveyor via the transfer conveyor. This process may then repeat to organize and store numerous mats.

Use of the inventive system solves many problems associated with current mat cleaning techniques. While conventional techniques waste large amounts of space by storing rolled mats, the inventive system is capable of storing mats in a vertical side-by-side method, thus significantly reducing the storage space needed for conventional techniques. Additionally, the exemplary system does not suffer from the inefficiency problems found in conventional techniques associated with organizing cleaned mats.

Because the control center may facilitate the proper organization of mats as they are cleaned and loaded, time spent in organizing mats after they have been rolled can be substantially reduced or eliminated. Additionally, the inventive system does not usually require the use of energy to dry the mats. Because the exemplary system may organize and store mats in an unrolled, hanging state, the mats can be “hang dried,” thus reducing or eliminating the high costs associated with removing water and cleaning agents from the mats.

Likewise, the inventive system does not suffer from problems associated with conventional tagging techniques. As discussed, mats may be tagged with an RFID that allows the mats to be tracked by the control center. Because the mat may be immediately organized along a carousel by the control center, it is unlikely that a mat will become misplaced before being properly organized. Further, because the mat is capable of being stored in an unrolled, hanging position, the mat is easily identifiable in the case that an identification device is lost or damaged.

The inventive system also offers a time saving and efficient method for retrieving and rolling mats. For example, after drying, storing or organizing, mats are usually rolled for shipment or further storage. The inventive system uses the control center to direct those mats that are to be rolled onto a transfer conveyor. From there, the mats may be moved to a dispatch conveyor which is connected to the elevator. The elevator may then lower the mats back to the loading station. From the loading station, the mats may be rolled utilizing a rolling mechanism and then may be removed from the loading station by a mat ejector. Utilizing the inventive system can reduce the time and labor required in conventional manual rolling techniques. Thus, the exemplary system offers significant advantages over current conventional techniques.

These and other aspects, objects, and features of the exemplary system will become apparent from the following detailed description of the exemplary embodiments, read in conjunction with, and reference to, the accompanying drawings.

### BRIEF DESCRIPTION OF THE DRAWINGS

FIG. 1 illustrates the basic components of a system and method for drying, handling, organizing and storing floor mats according to an exemplary embodiment of the invention.

FIGS. 2A-E illustrate a hanging device according to an exemplary embodiment of the invention.

FIG. 3 illustrates the basic components of a loading station according to an exemplary embodiment of the invention.

FIGS. 4-11 illustrate how a mat is loaded via a loading station onto a hanging device and lifted by an elevator according to an exemplary embodiment of the invention.

FIGS. 12-16 illustrate how a mat is rolled by a loading station according to an exemplary embodiment of the invention.

FIG. 17 illustrates the basic components of an organizer conveyor according to an exemplary embodiment of the invention.

FIG. 18 illustrates the basic components of an initial transfer conveyor according to an exemplary embodiment of the invention.

FIGS. 19A-B illustrate the basic components of a clip accumulator conveyor and an exploded view of the transfer chain, respectively, according to an exemplary embodiment of the invention.

FIG. 20 is a flow chart illustrating a system and method for drying, handling, organizing and storing floor mats according to an exemplary embodiment of the invention.

### DETAILED DESCRIPTION OF EXEMPLARY EMBODIMENTS

The inventive system can provide a system and method capable of handling, organizing, drying and storing different types of planar objects, including, but not limited to, floor mats of different shapes and sizes. The system is capable of handling and drying cleaned floor mats by loading the floor mats onto a primary organizing carousel that receives commands from a control center, thereby facilitating proper organization of the mats. Further, the system is capable of preparing mats for shipment or secondary storage.

By allowing the mats to be organized and stored in a vertical hanging position, the inventive system alleviates problems associated with conventional mat cleaning techniques. Specific problems include, but are not limited to, wasted time and energy needed for drying mats according to conventional cleaning techniques, lack of efficiency in organizing and storing floor mats according to conventional cleaning techniques, and lack of efficiency in identifying mats after they are cleaned according to conventional cleaning techniques. Accordingly, these and other problems not mentioned may be resolved by the inventive system.

The inventive system may comprise the following: a loading station that receives a planar object, a hanging device that attaches to the planar object, an elevator that lifts the planar object, a carousel that stores the planar object, and a control center that controls the inventive system. Exemplary embodiments of the inventive system will be described in more detail below with reference to the accompanying drawings in which like reference numerals represent like elements.

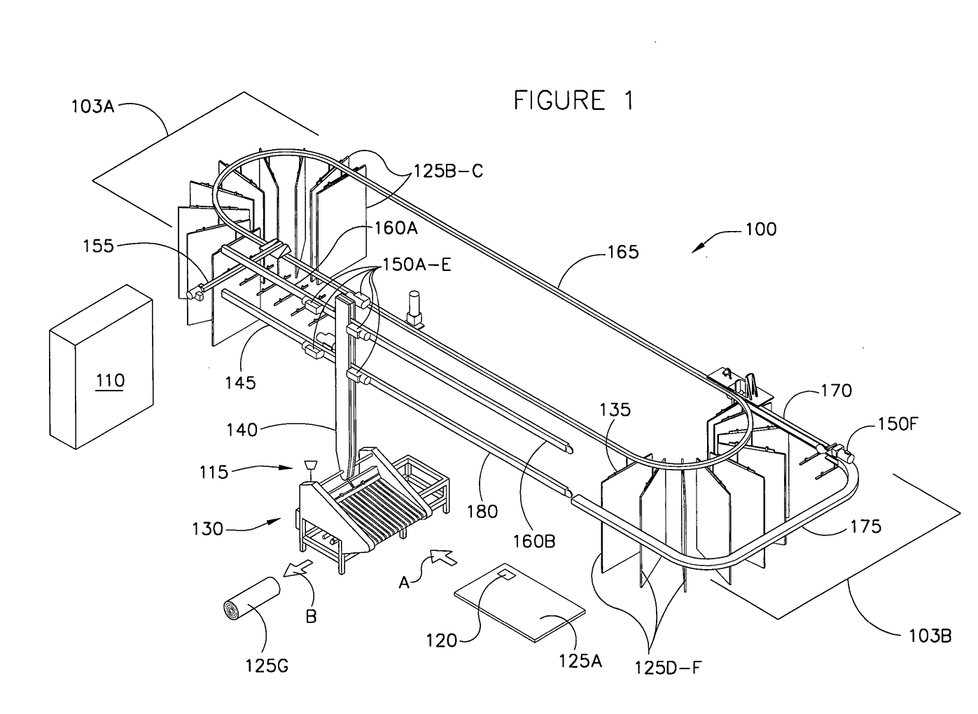

FIG. 1 illustrates the basic components of a system and method for drying, handling, organizing and storing floor mats according to an exemplary embodiment of the inventive system. In the exemplary embodiment illustrated in FIG. 1, the system 100 comprises a control center 110 and a loading station 130. As shown by arrow A, a floor mat 125 may be placed onto the loading station 130. One of ordinary skill in the art will know that the floor mat 125 may be comprised of any number of materials; for example, the mat 125 may be made of rubber, woven fiber, or a combination thereof. Additionally, although in FIG. 1 the exemplary embodiment of the planar object is a floor mat, one of ordinary skill in the art will recognize that the inventive system is not limited to a floor mat handling environment. Accordingly, other potential applications of the inventive system may include, but are not limited to, handling, organizing, and storing charts, posters, carpets, building materials, paintings, planar sheets of materials, and other planar objects.

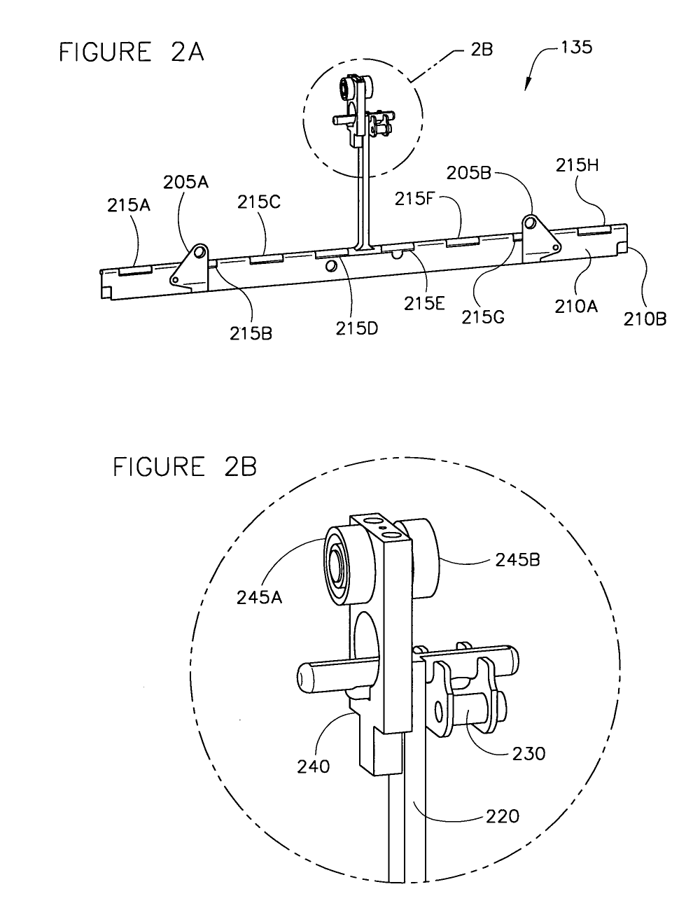

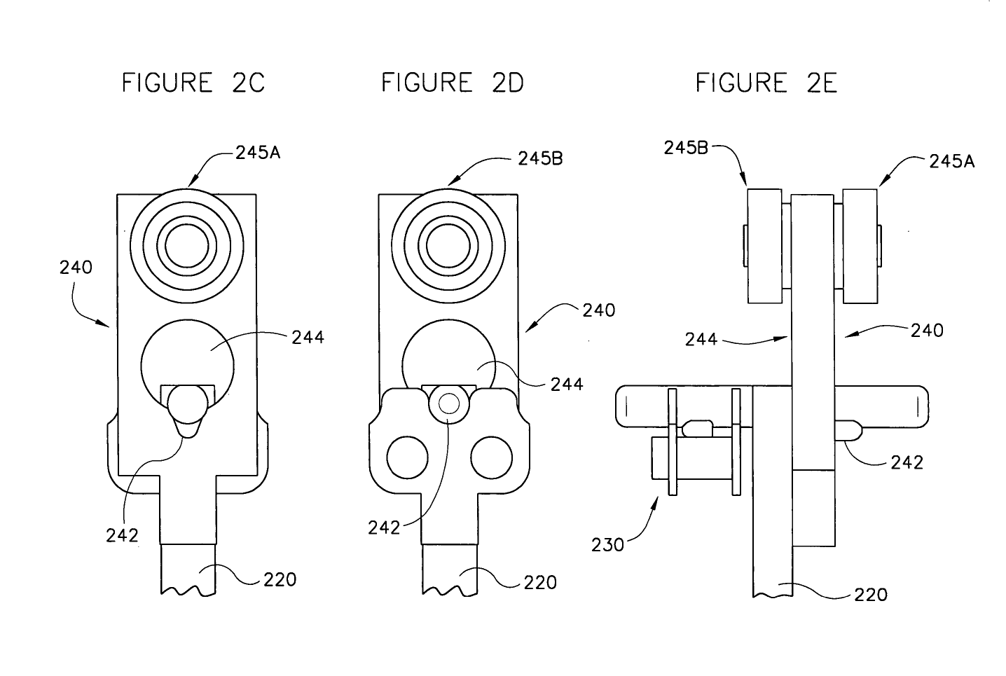

The inventive system 100 may further comprise one or more hanging devices 135 which may be raised by an elevator 140 to one or more conveyors, for example, conveyors 145, 155, or 165. As illustrated in FIG. 1, one exemplary embodiment of the hanging device 135 comprises a t-shaped clamping system. Further details of the hanging device will be described below with respect to FIG. 2. Those skilled in the art will recognize that other embodiments of the hanging device 135 may be utilized without departing from the scope and spirit of the inventive system 100.

The loading station 130 may place the mat 125 onto the hanging device 135. The hanging device 135, in turn, may be lifted by the elevator 140. The loading station 130 and hanging device 135 may be made from steel in this embodiment, while the elevator 140 may be made from plastic. One of ordinary skill in the art, however, will know that the inventive system is not limited to the above-listed materials. Accordingly, the hanging device 135, loading station 130 and elevator 140 may comprise steel, aluminum, plastic, titanium, wood or other similar materials.

The inventive system 100 may further comprise a primary accumulator conveyor 145, an initial transfer conveyor 155, an organizer conveyor 165, as well as clip accumulator conveyors 160A-B. Each conveyor 145, 155, 160A-B, and 165 may be made from steel or the like. Accordingly, each conveyor 145, 155, 160A-B, and 165 may comprise steel, aluminum, plastic, titanium, wood or other similar materials.

In the inventive system, each conveyor 145, 155, 160A-B, and 165 comprises a motor 150 that drives chains (not illustrated in FIG. 1) of each respective conveyor. Additionally, the elevator 140 may also function as a conveyor by utilizing a motor 150 and drive chains (not illustrated). One of ordinary skill in the art understands how the conveyors and elevator operate and work with respect to the motors 150. Further, one of ordinary skill in the art understands that other means may be used to operate the conveyors; for example, belts may be substituted for chains in the conveyors without leaving the scope and spirit of the inventive system 100.

According to the inventive system 100, the mat 125 may be transferred from the elevator 140 to the primary accumulator conveyor 145 via the hanging device 135. After the mat 125 is transferred to the primary accumulator conveyor 145, the control center 110 may pre-position the organizer conveyor 165 so that the mat 125 may be placed on the conveyor 165 at a predetermined location. The control center loads each mat 125 at the predetermined location so that groups of mats 125 can be positioned along sections 103A and 103B of the organizer conveyor 165. For example, the first section 103A of the organizer conveyor 165 may be arranged to store mats 125 for a first customer. Meanwhile, the second section 103B of the organizer conveyor 165 may be arranged to store mats for a second customer.

When the organizer conveyor 165 is pre-positioned, the mat 125 may be transferred from the primary accumulator conveyor 145 to the initial transfer conveyor 155 and then to the organizer conveyor 165. In other words, the control center 110 moves the organizer conveyor 165 in a manner such that each floor mat 125 is loaded onto the organizer conveyor 165 according to a stacking order. At this point, the process may be repeated and other mats 125 may be organized according to the above-disclosed inventive system.

The control center 110 may comprise a cabinet that can house the hardware or software or combination thereof for running the inventive system 100. The cabinet for the control center 110 may be made from any number of materials, including, but not limited to, steel, aluminum, plastic, titanium, wood or other similar materials. The control center 110 may constantly reference a database which determines what to do with each mat 125 as it enters the loading station 130. In this regard, the system 100 is able to automatically sort and dispatch mats 125 by route/delivery order when a particular route is requested by the operator. The hardware in the control center 110 can comprise electronics such as central processing units that may run or execute one or more programs. A skilled programmer or engineer would be able to write a computer program or identify the appropriate hardware circuits to implement the disclosed inventive system without difficulty based upon the attached drawings and associated descriptions in this text. Therefore, disclosure of a particular set of program code instructions or detailed hardware devices is not considered necessary for an adequate understanding of how to make and use the inventive system. The inventive functionality of the claimed computer-implemented processes will be explained in more detail in the following description in conjunction with the figures.

The inventive system 100 may further comprise an off-going transfer conveyor 170, a link conveyor 175, and a dispatch conveyor 180. Each of these conveyors 170, 175 and 180 may also be made of steel, however, one of ordinary skill in the art is aware that the conveyors 170, 175 and 180 may be made from any number of materials including, but not limited to, steel, aluminum, plastic, titanium, wood or other similar materials.

In the exemplary embodiment of the inventive system 100 shown in FIG. 1, the control center 110 may direct that the organizer conveyor 165 move so that certain mats 125 can be moved from the organizer conveyor 165 to the off-going transfer conveyor 170. For instance, the control center 110 may determine that a group of mats 125 on section 103A of the organizer conveyor 165 need to be shipped. The control center 110 would, in this case, move the group of mats 125 on section 103A from their position at 103A to a position where the group of mats 125 could transition to the link conveyor 175. From here, the group of mats 125 would be moved off of the organizer conveyor 165 and onto the link conveyor 175.

From the link conveyor 175, mats 125 would be moved onto the dispatch conveyor 180. The dispatch conveyor 180 may be coupled to the elevator 140. In this way, the mat 125 may be moved to the elevator 140 and then proceed back to the loading station 130. The loading station 130, in turn, is capable of uncoupling the mat 125 from the hanging device 135, reading and sending information concerning the mat 125 to the control center 110, and rolling the mat 125 for storage or shipment. Further, as illustrated by arrow B, after being rolled by the loading station 130, the mat 125 may be ejected for further storage or shipment.

The inventive system may further comprise an identification device 120 and an antenna 115 for communicating with the control center 110. The identification device 120 may be mounted to the mat 125 and may communicate with the antenna 115. The antenna 115 may be part of an interrogator that generates signals to activate and read the identification device 120 or may simply receive information from the identification device 120. Additionally, the antenna 115 may be used to communicate with the various motors 150 of the different conveyors of the system 100. While the antenna 115 is illustrated as being attached to the loading station 130 in the exemplary embodiment, it could be placed in any number of locations, such as on or adjacent to motors 150, without departing from the spirit and scope of the inventive system. Also, the control center 110 can be coupled to each of the system components through other types of communication links. Other connection links include, but are not limited to, infrared, acoustic, wired, and other wireless types of links.

In one exemplary embodiment, the identification device 120 on each mat 125 may be a radio frequency identification device (RFID) which may be embedded within the mat 125 or attached to the mat 125. In this embodiment, the identification device 120 may comprise active or passive type RFID tags. Specifically, the identification device 120 can comprise passive tags which do not require any separate power source and are powered by the interrogation signals produced by the antenna 115 of the loading station 130. Alternatively, the identification device 120 can comprise active tags which utilize a battery such that each device 120 produces communication signals that are transmitted to the antenna 115 without any dependency on the power from the signals produced by the antenna 115.

Further, each identification device 120 may comprise readable and writable memory areas that can store various information about a particular floor mat 125. Such information can include, but is not limited to, a customer name, a customer address, the date and time in which a particular mat 125 was cleaned, a date and time in which a particular mat 125 was removed from a customer's premises, a date and time in which a mat 125 is due back for a return to the customer's premises, and other like information. Alternatively, the control center 110 may store some or all of the above information and the identification device 120 may only have limited information about the mat 125 that it accompanies, such as a unique customer number or unique customized mat number.

For example, the identification device 120 may be encoded with a unique identification code (e.g., binary reference number) that is read and stored by the control center 110 as the mat 125 enters the loading station 130. With this information, the control center 110 may compare the mat's 125 unique identification to a database of stored information and, by so doing, direct the system 100 such that the mat 125 is properly organized with other like mats. Also, by storing the info, the control center 110 is able to maintain a dynamic mat inventory. One of ordinary skill in the art will appreciate that the amount of information that could be stored by the identification device 120 and control center 110 is unlimited. Additionally, one of ordinary skill in the art will understand that the method by which the information may be stored and utilized by the identification device 120 and control center 110 is also unlimited.

While the control center 110 is illustrated as a single component in FIG. 1, one of ordinary skill in the art will understand that the hardware or software or combination of this component can reside across multiple, different machines in different locations without departing from the scope and spirit of the inventive system. In a networked computer environment, program modules for running the system 100 may be stored in remote memory storage devices.

One of ordinary skill in the art will appreciate that the inventive system 100 may be implemented with other computer system configurations, including, but not limited to, handheld devices, multi-processor systems, microprocessor-based or programmable consumer electronics, networked personal computers, minicomputers, mainframe computers, and the like. Likewise, the inventive system 100 may comprise a computer program or hardware or combination thereof which embodies the functions described herein and illustrated in the attached drawings. It should be apparent, however, that there could be many ways of implementing the inventive system 100 in computer programming or hardware design, and the inventive system 100 should not be construed as being limited to any one set of computer program instructions.

Further, the inventive system 100 may be practiced in a distributed computing environment where tasks may be performed by remote processing devices that are linked through a communications network such as the Internet. In a distributed computing environment, program modules may be located in both local and remote storage devices.

It should also be understood that any programs, processes, methods, or the like described herein are not related or limited to any particular computer or apparatus. Rather, various types of general purpose machines may be used with the following processes and devices in accordance with the teachings described herein.

Turning now to FIG. 2A, further details of an exemplary embodiment of the hanging device 135 are illustrated through a normal view. The exemplary embodiment of the hanging device 135 is illustrated as a t-shaped clamping system. In this embodiment, the hanging device 135 comprises clamping mechanisms 205A-B, clamping portions 210A-B, and hinges 215A-H. The clamping portions 210A-B are held together by the hinges 215A-H. The clamping portions 210A-B engage the mat 125 by the clamping force of the clamping mechanisms 210A-B. The clamping mechanisms 205A-B create force by squeezing together through the force of a spring or other mechanical exertion. The parts of the hanging device 135 may be made of steel, however, one of ordinary skill in the art is aware that the these parts may likewise be made from any number of materials including, but not limited to, steel, aluminum, plastic, titanium, wood or other similar materials.

The exploded view in FIG. 2B further illustrates the exemplary embodiment of the hanging device 135. In this view, the hanging device 135 comprises a t-shaped portion 220 which is connected to an eye holder piece 240 that further comprises rollers 245A-B, each contributing to the movement of the hanging device 135 from one conveyor to another. In this exemplary embodiment, the t-shaped portion 220 allows the hanging device to be transferred from one conveyor to another by allowing, for example, a chain link 230 of a conveyor (not illustrated in FIG. 2B) to engage one half of the “T” shape. Thus, one half of the t-shaped portion 220 may be engaged by one chain link 230 of one conveyor (not illustrated in FIG. 2B) while another half of the t-shaped portion 220 may later be engaged by a second chain link 220 of a second conveyor (not illustrated in FIG. 2B) or the eye holder piece 240. One of ordinary skill in the art will appreciate how the exemplary embodiment of the inventive system utilizes the t-shaped portion 220, the eye holder piece 240, and rollers 245A-B to facilitate movement along the various conveyors in the system 110.

FIGS. 2A-C further illustrate the components of the exemplary embodiment of the hanging device 135. FIG. 2C illustrates in detail the right side of the hanging device 135. From this view, it is apparent that the t-shaped portion 220 sits in a lower slot 242 of the hanging device 135. Additionally, this view shows that a hole 244 in the eye holder piece 240. This hole 244 is much larger than the side of the t-shaped portion 220 that is inserted into the eye holder piece 240. This allows for the t-shaped portion 220 to exit the eye holder piece 240 when it is transferred to another conveyor. For example, at the off-going transfer conveyor 170 (not illustrated in FIG. 2C), the t-shaped portion 220 may disconnect from the eye piece holder 240 so that the hanging device 135 may be carried by the transfer conveyor. When this occurs, a chain link 220 (not illustrated in FIG. 2C) lifts the t-shaped portion into the hole 244 of the eye holder piece 240 so that it may be removed.

FIG. 2D illustrates in detail the left side of the hanging device 135 according to an exemplary embodiment. The left side of the t-shaped portion 220 is engaged by a chain link 230. As can be seen from the illustration, the chain link 230 engages an opposite side of the t-shaped portion 220 than does the eye holder piece 240. In this way, the chain link 220 may engage and remove the t-shaped portion 220 from the eye holder piece 240. Alternatively, the chain link 230 may engage the t-shape portion 220 and facilitate the movement of the hanging device 135 down a conveyor by utilizing the rollers 245A-B to move the hanging device 135.

FIG. 2E illustrates the front of the hanging device 135 according to an exemplary embodiment. As mentioned above, the chain link 230 and the eye holder piece 240 are located on opposite sides of the t-shaped portion 220 so that the chain link 230 may pull the eye-piece holder 240 along a conveyor or so that the chain link 230 may carry the t-shaped portion 220 without utilizing the eye piece holder 240. For instance, the chain link 230 may move the t-shaped portion 220 without the eye piece holder 240 if the hanging device 135 is not attached to a mat 125. Additionally, as stated before, the chain link 230 may engage the t-shaped portion 220 of the hanging device 135 and facilitate the movement on a conveyor by pulling the eye holder piece 240 down the length of the conveyor. If this occurs, the rollers 245A-B hold the weight of the hanging device 135, along with the mat 125, if attached, and roll down the length of the conveyor to move the mat 125 by the pull of the chain link 230.

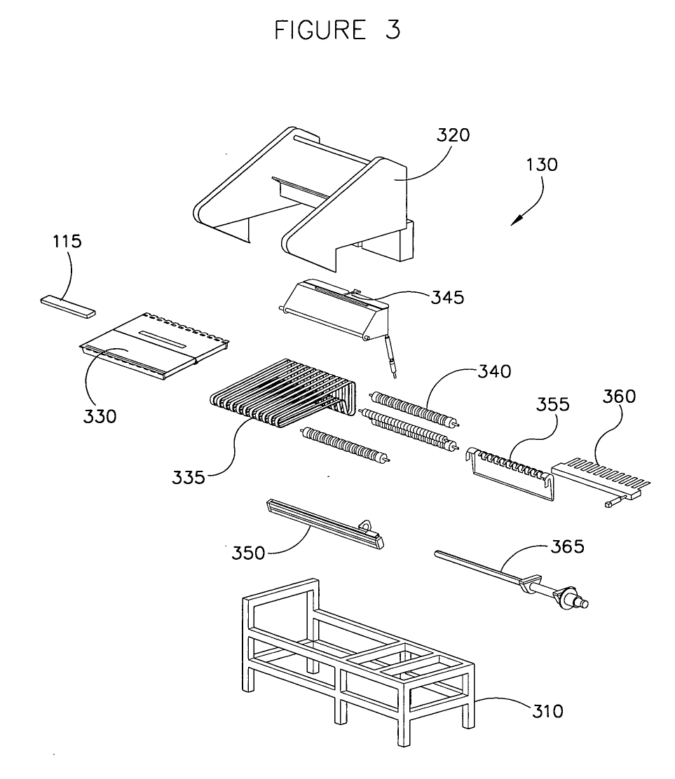

Turning to FIG. 3, the basic components of a loading station 130 according to an exemplary embodiment of the inventive system are illustrated. According to this exemplary embodiment, the loading station 130 may comprise a stand 310, a frame 320, a hanging device manipulator 345, a conveyor pan 330, conveyor belts 335, belt rollers 340, a mat rolling chassis 355, a horizontal transfer facilitator 360, a mat ejector 350, and a mat rolling shaft 365. These parts, except for the conveyor belts 335, may be made of steel, however, one of ordinary skill in the art will recognize that the parts of the loading station 130 may be made from any number of materials including, but not limited to, steel, aluminum, plastic, titanium, wood or other similar materials. Similarly, one of ordinary skill in the arts will know that the conveyor belts 335 may be made of a number of materials such as, but not limited to, rubber, plastic, or nylon.

The exemplary embodiment also may include the antenna 115 to facilitate communication with the identification device 120 and control center 110. It should be noted that while certain parts of the loading station 130 are illustrated in the exemplary embodiment as having specific parts, one of ordinary skill in the art would appreciate that the loading station 130 could be constructed in numerous configurations. For example, numerous parallel conveyor belts 335 are illustrated, however, one of ordinary skill in the art would appreciate that the conveyor belts 335 could be substituted with a wide, flat belt.

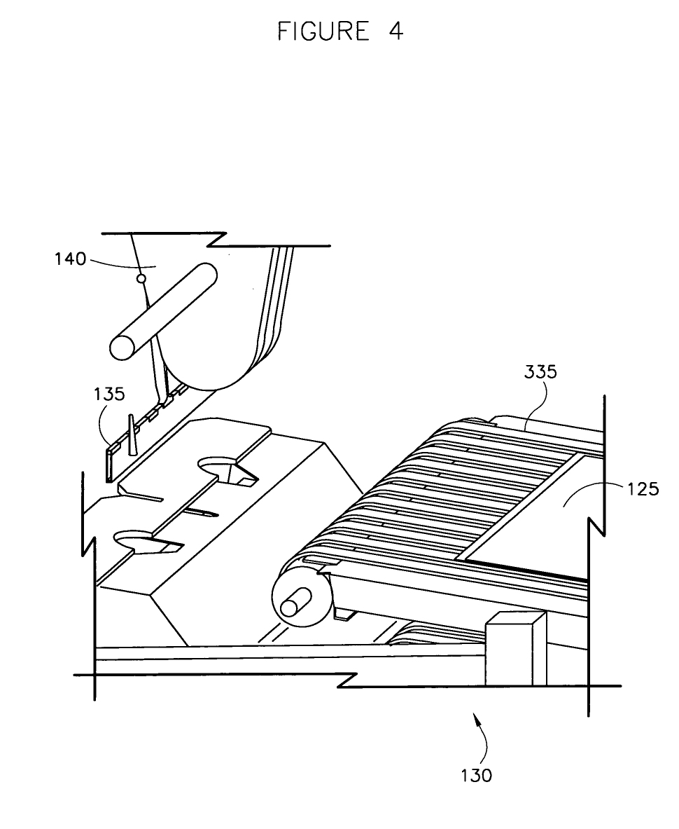

FIGS. 4 through 11 illustrate how the loading process of the inventive system 100 operates according to an exemplary embodiment. The loading station 130 operates by utilizing various photo and proximity sensors (not illustrated) which guide mats 125 through the system 100. In FIG. 4, a mat 125 is placed on the rolling conveyor belts 335 of the loading station 130. At this time, the elevator 140 may lower the empty hanging device 135 towards the loading station 130. Additionally, at this time, the antenna 115 (not illustrated in FIGS. 4-11) may communicate with the mat's 125 identification device 120 (not illustrated in FIGS. 4-11) and the control center 110 (not illustrated in FIGS. 4-11).

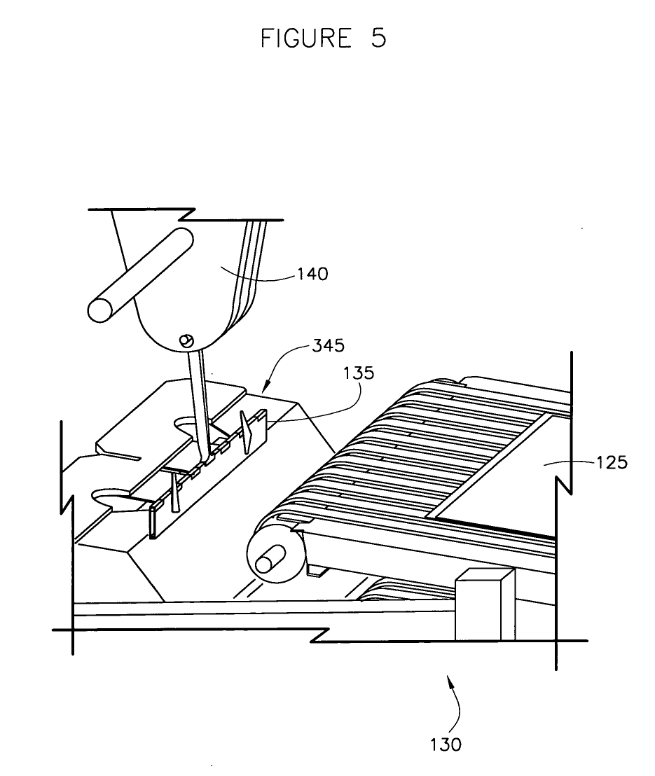

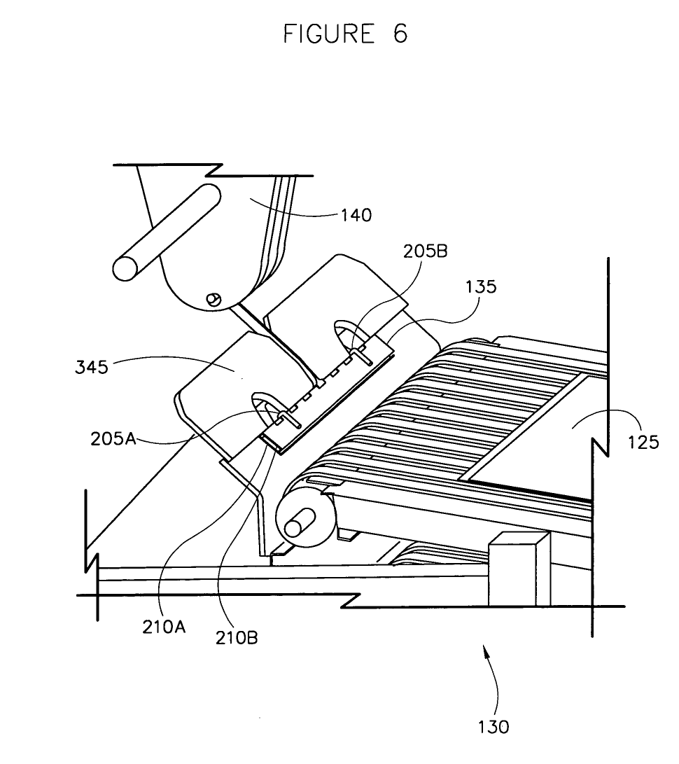

In FIG. 5, the elevator 140 has lowered the hanging device 135 to the hanging device manipulator 345 of the loading station 130. In FIG. 6, the hanging device manipulator 345 engages the hanging device 135 and disengages the clamping mechanisms 205A-B so that the clamping portions 210A-B can be positioned to accept the mat 125. This may be done by sliding the clamping mechanisms 205A-B from the clamping portions 210A-B so that the clamping portions 210A-B can be opened to accept the mat 125.

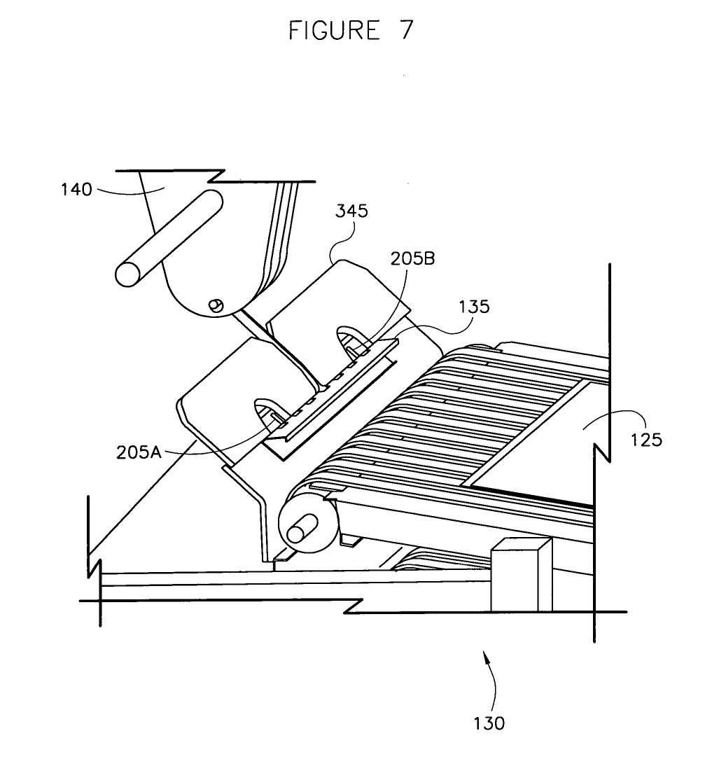

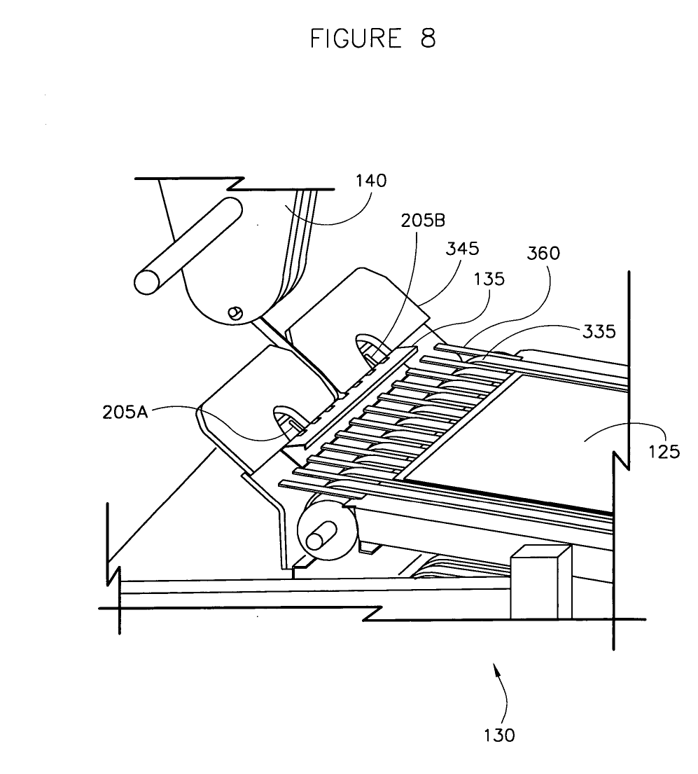

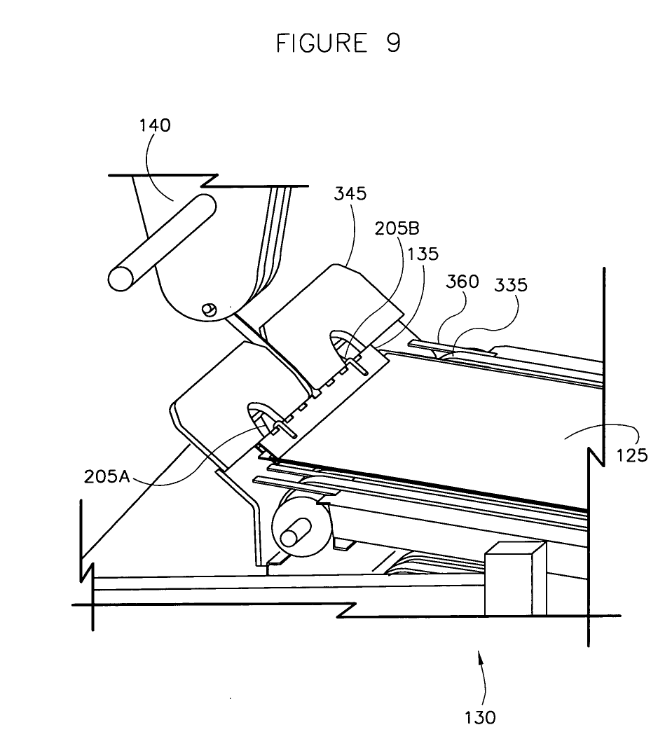

FIG. 7 illustrates the hanging device 135 after the clamping portions 210A-B have been opened and are ready to receive the mat 125. In FIG. 8, the horizontal transfer facilitator 360 is extended to help facilitate the transfer of the mat 125 to the hanging device 135. The rolling conveyor belts 335 of the loading station 130 move the mat 125 to the clamping portions 210A-B of the hanging device 135. The clamping mechanisms are then engaged by the hanging device manipulator 345 to secure the mat 125 to the hanging device 135. FIG. 9 illustrates the mat 125 after it has been coupled to the hanging device 135. The mat 125 is coupled to the hanging device 135 by allowing the clamping mechanisms 205A-B to reapply their squeezing force to the clamping portions 210A-B.

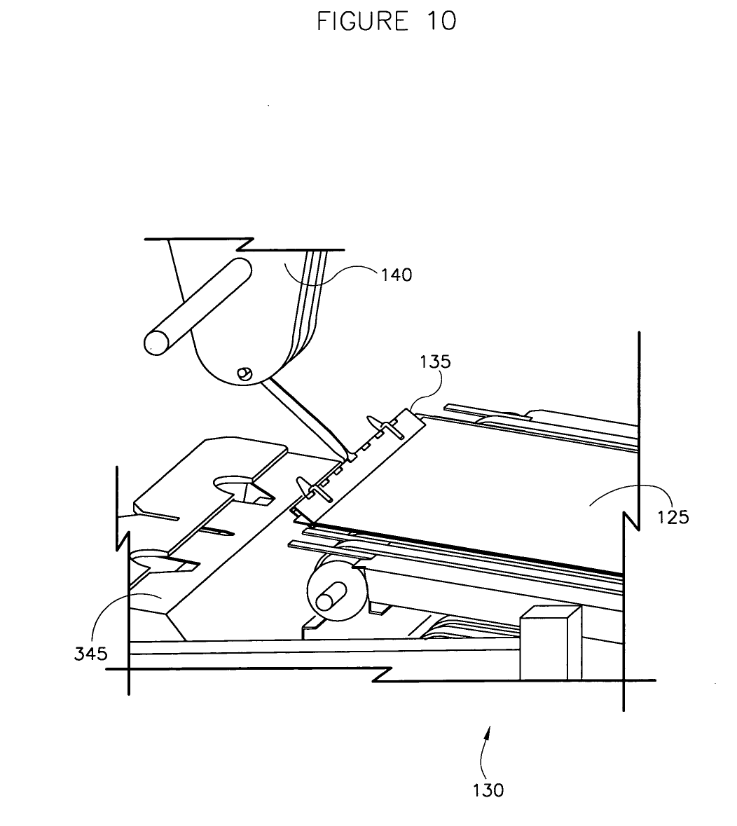

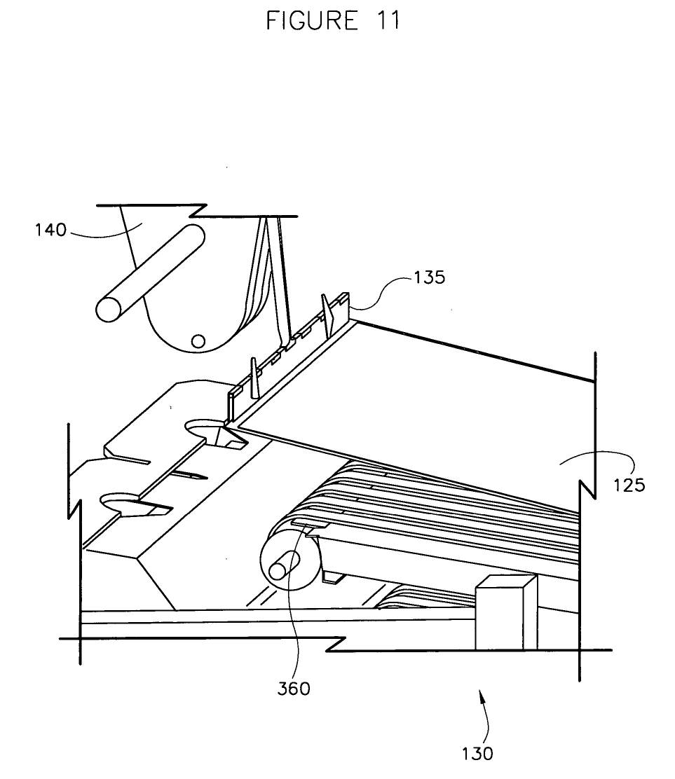

In FIG. 10, the hanging device manipulator 345 disengages the hanging device 135 to allow the mat 125 to be lifted upward by the elevator 140. In FIG. 11, the elevator 140 moves the mat 125 via the hanging device 135 vertically so as to place the mat 125 into a hanging position along a conveyor such as the primary accumulator conveyor 155 (not illustrated in FIGS. 4-11). Once the mat 125 is vertically hung, it may be dried and organized accordingly.

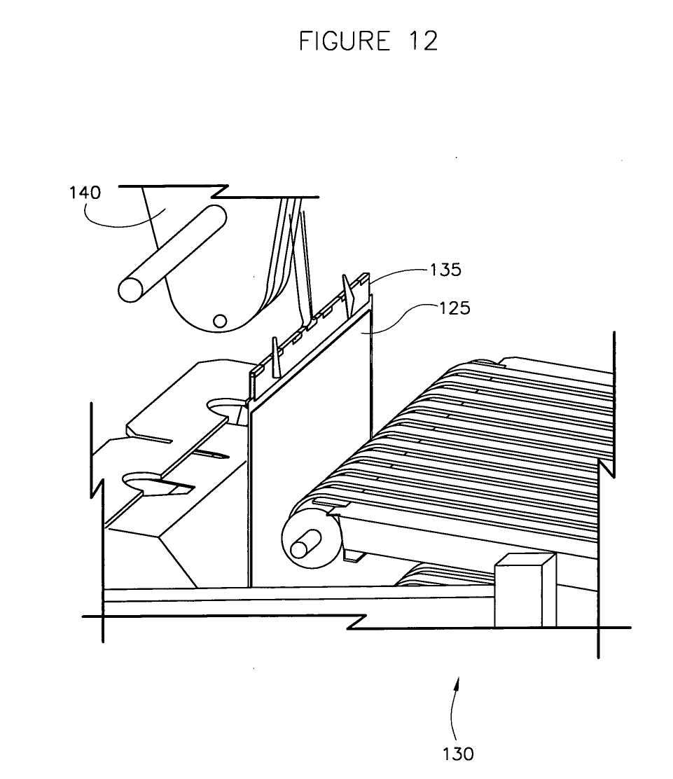

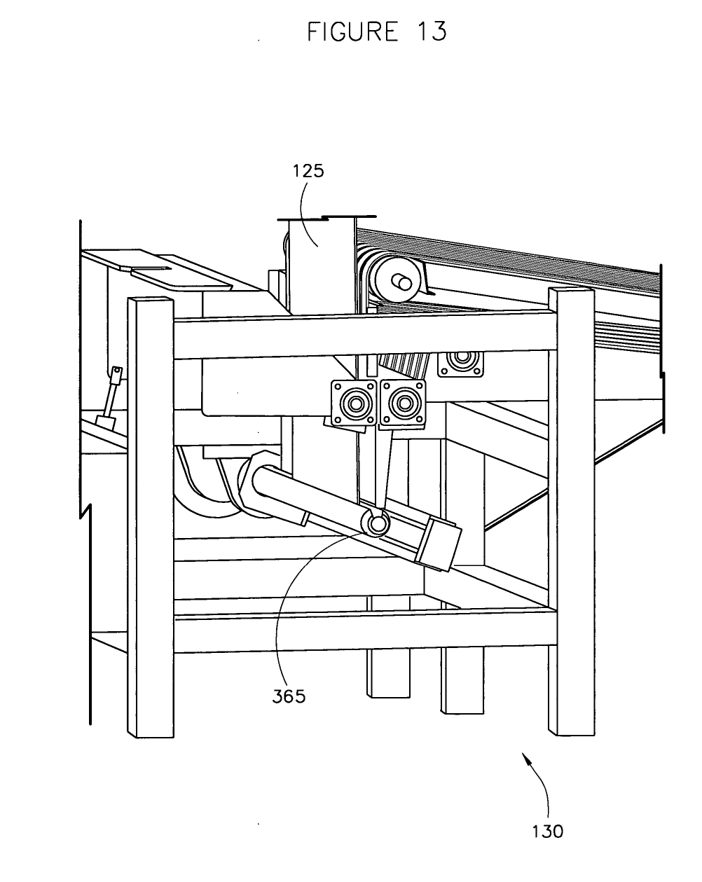

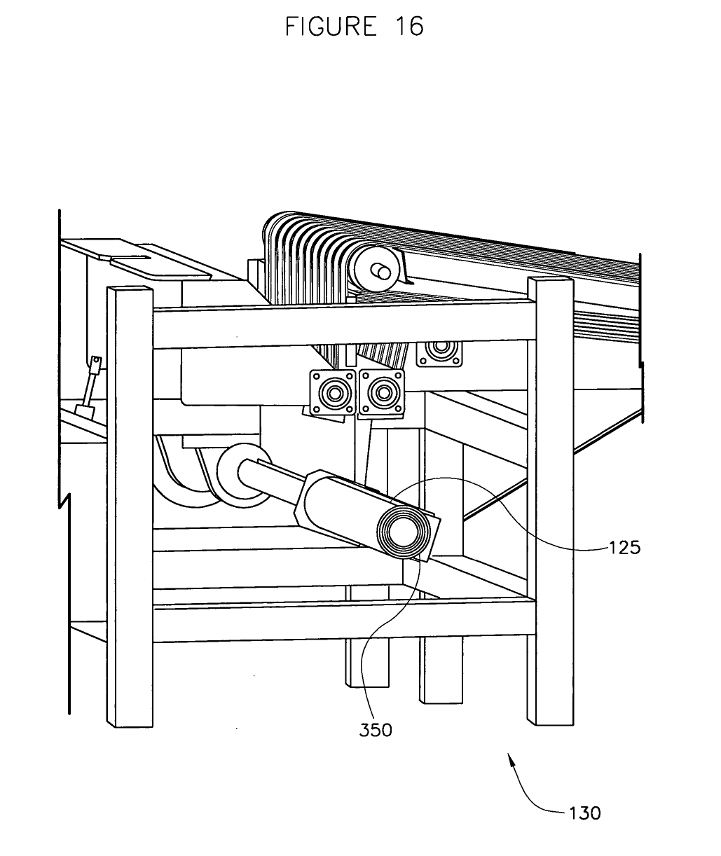

FIGS. 12 through 16 illustrate how a mat 125 is rolled according to an exemplary embodiment of the inventive system. In FIG. 12, when it is time to remove a mat 125 from the system 100, the mat 125 is lowered down to the loading station 130 by the elevator 140. In FIG. 13, the mat roller shaft 365 engages the mat 125. The mat roller is “C” shaped and contains an integral clamp. The mat 125 is inserted into the open end of the mat roller shaft 365 and the integral clamp is closed to hold the mat 125 so that it may be rolled.

Once connected to the mat roller shaft 365, the mat 125 may be identified by its identification device 120 (not illustrated in FIGS. 12-16) and the antenna 115 (not illustrated in FIGS. 12-16 may communicate the information to the control center 110. By so doing, the control center 110 may update its dynamic mat inventory.

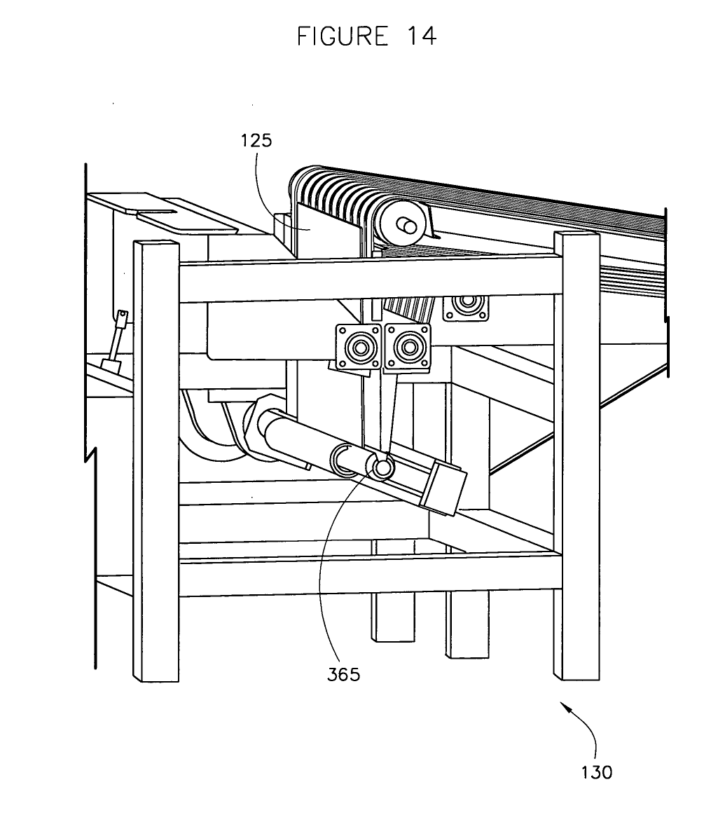

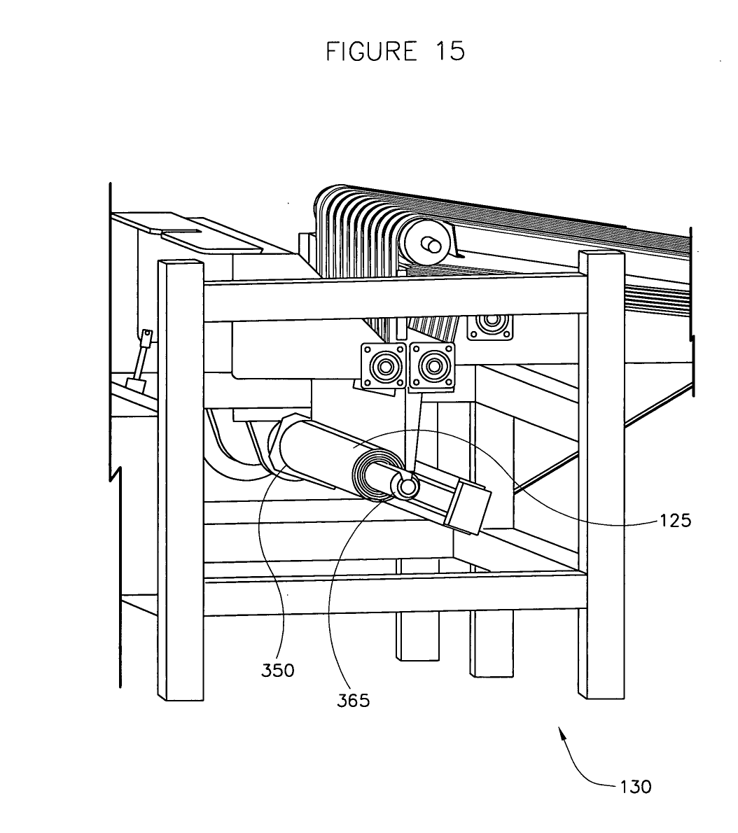

In FIGS. 14 and 15, the mat roller shaft 365 rolls the mat 125 so that the mat can be stored or shipped. By so doing, the time-consuming and cumbersome task of manually rolling mats 125 is alleviated by the inventive system 100. Once the mat 125 is fully rolled, the integral clamp of the mat roller shaft 365 releases (i.e., the end of the mat 125 is released) and the mat is pushed off the mat roller shaft 365 by the mat ejector 350. This is illustrated in FIG. 15; the mat ejector 350 ejects the rolled mat 125 from the loading station 130 so that the mat 125 may be removed from the loading station 130 and stored or shipped.

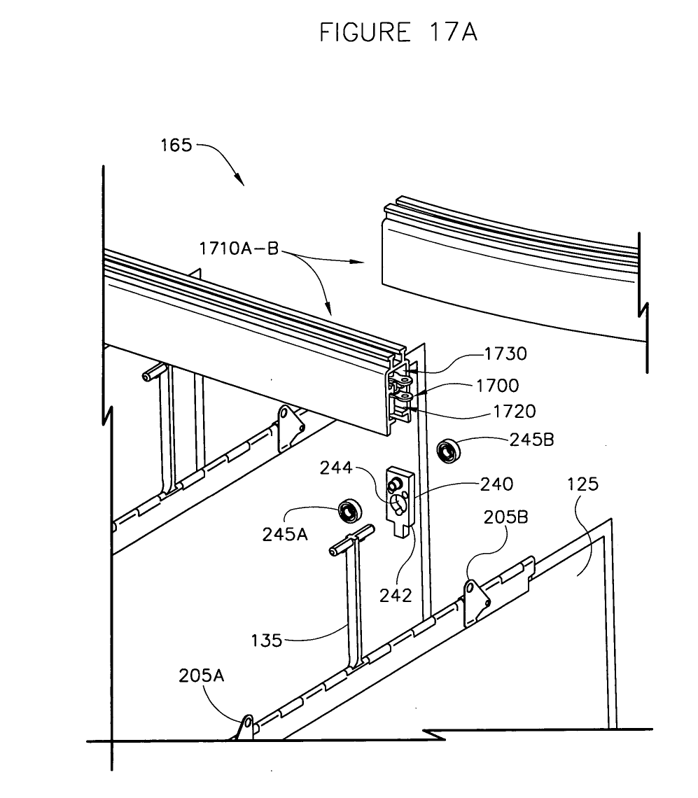

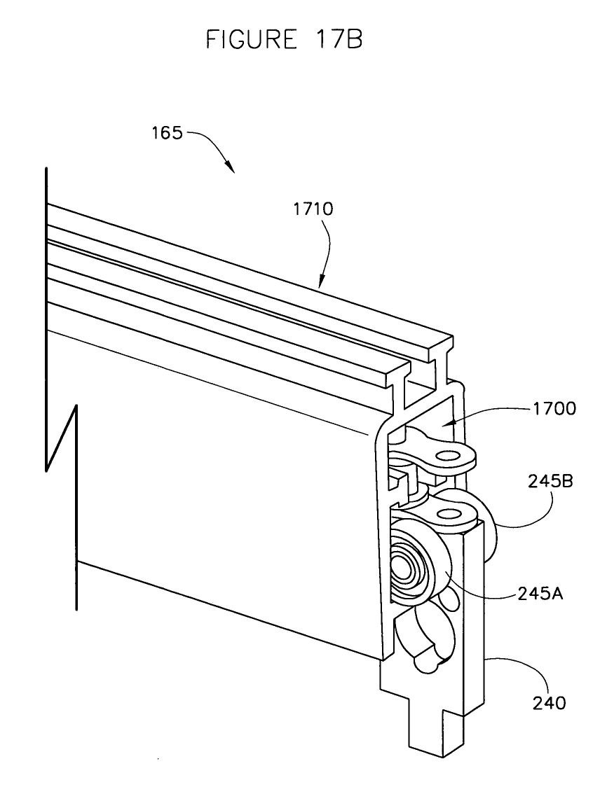

FIG. 17A illustrates the basic components of an organizer conveyor 165 according to an exemplary embodiment of the inventive system. In this embodiment, the organizer conveyor 165 comprises an organizer beam 1710 and a chain 1700. The chain 1700 facilitates the movement of the rollers 245A-B of the hanging device 135 down the length of the organizer beam 1710A. The organizer beam 1710A further comprises a first channel 1720 and a second channel 1730. The chain link portion of the chain 1700 occupies most of the second channel 1730 while a pin extends from the chain 1700 down into the first channel 1720. This pin portion of the chain 1700 engages the eye holder piece 240 and pushes the eye holder piece 240 that supports the hanging device 135 down the length of the organizer beam 1710.

FIG. 17B further illustrates the movement of the hanging device 135 down the organizer conveyor 165. As is illustrated, the rollers 245A-B proceed down the first channel 1720 as the chain 1700 pushes the eye holder piece 240. When the opposite side of the hanging device 135 engages a chain link 230 (not illustrated in FIG. 17B) or other movement device of another conveyor, the hanging device may disconnect from the eye holder piece 240 which runs through the organizer beams 1710, thus facilitating a transfer of the hanging device 135 to another conveyor (not illustrated in FIG. 17B). It should be noted, however, that when the hanging device is moving along the length of the organizer beams 1710, the t-shaped portion 220 cannot be removed from the eye holder piece 240 because the organizer beam 1710 does not allow enough room for the t-shaped portion 220 to be lifted out of the lower slot 242 into the hole 244 of the eye holder piece 240 so that it may be removed. Thus, the t-shaped portion 220 can only be transferred at certain transfer points (not illustrated in FIG. 17B); for example, the t-shaped portion 220 may be removed from, or attached to, the eye holder piece 220 at the transfer point between the organizer conveyor 165 and the off-going transfer conveyor 170. Likewise, this may occur at the transfer point between the organizer conveyor 165 and the initial transfer conveyor 155.

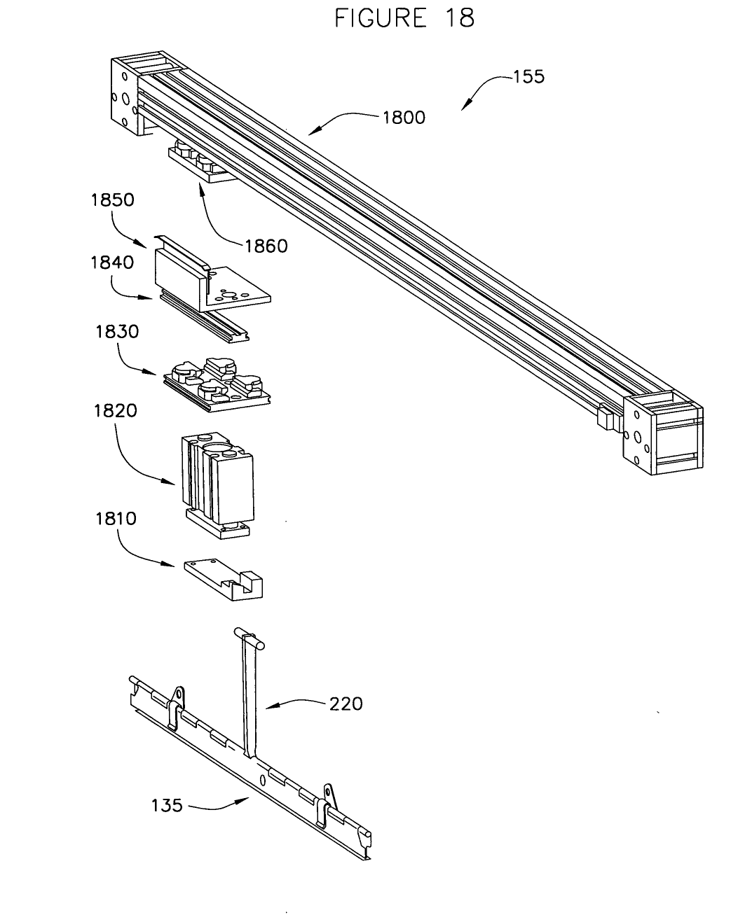

FIG. 18 illustrates the basic components of an initial transfer conveyor 155 according to an exemplary embodiment of the inventive system 100. In this embodiment, the initial transfer conveyor 155 comprises a transfer beam 1800, a transfer cradle 1810, a lift cylinder 1820, a bearing carriage 1830, a guide track 1840, a support bracket 1850, and a transfer slide 1860. The transfer cradle 1810 interacts with the hanging device 135 to facilitate a transfer of the hanging device 135 along the length of the initial transfer conveyor 155. More specifically, the hanging device 135 is placed into the transfer cradle 1810 by a chain 230 (not illustrated in FIG. 18) of the primary accumulator conveyor 145 (not illustrated in FIG. 18). The transfer cradle 1810 is, in turn, connected to the lift cylinder 1820, the bearing carriage 1830, the guide track 1840, a support bracket 1850 and ultimately the transfer slide 1860. These parts cradle the hanging device 135 and clamp it so that it may ascend down the length of the organizer beam 1710 in a controlled fashion.

The transfer slide 1860 moves down the length of the transfer beam 1800 with the other parts connected in-tow there under. When the transfer slide 1860 reaches the end of the transfer beam 1800, one side of the t-shaped portion 220 of the hanging device 135 engages with another conveyor, for example, the organizer conveyor 165 (not illustrated in FIG. 18). From this point, the transfer slide 1860 returns to its initial position on the transfer beam 1800, leaving the hanging device 135 connected to the other conveyor (not illustrated in FIG. 18).

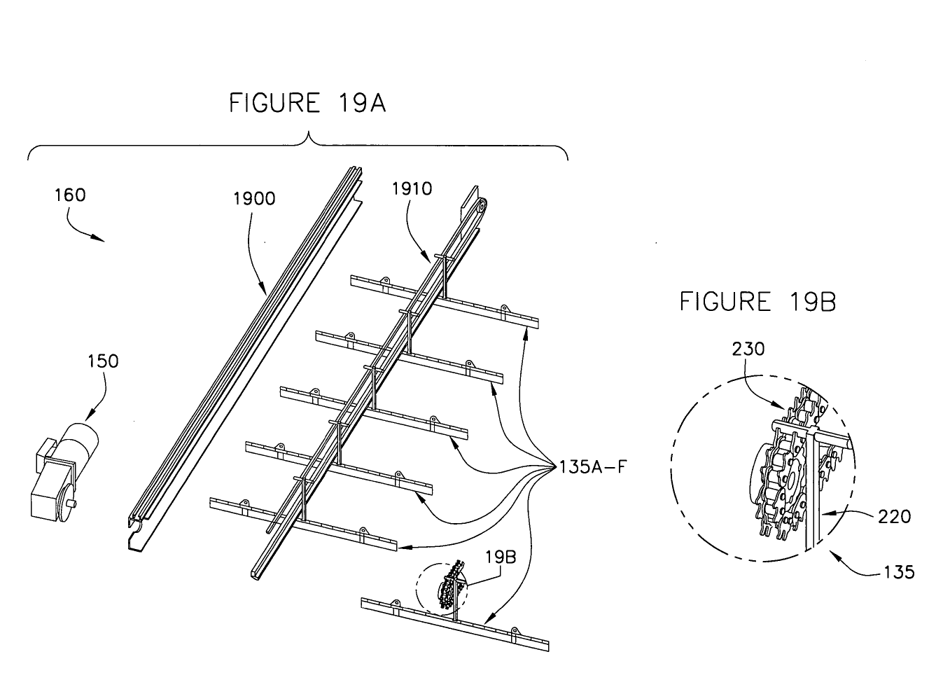

FIG. 19A illustrates the basic components of a clip accumulator conveyor 160 according to an exemplary embodiment of the inventive system. The clip accumulator conveyor 160 is utilized to recycle vacant hanging devices 135. For example, when a mat 125 has been taken down the elevator 140 and rolled by the loading station 130, the elevator takes the vacant hanging device 135 to the clip accumulator conveyor 160 and the vacant hanging device 135 is deposited. Thus, the hanging device 135 can be stored for future mat 125 organization. Accordingly, when a mat 125 is to be loaded, the elevator 140 can retrieve vacant hanging devices 135 from the clip accumulator conveyor 160 and proceed to the bottom in order to pick up a mat 125 at the loading station 130 (not illustrated in FIG. 19A).

In this exemplary embodiment, the clip accumulator conveyor 160 comprises an accumulator beam 1900 and an accumulator chain 1910. As shown in FIG. 19A, the accumulator chain 1910 is utilized to move the hanging devices 135A-F. The motor 150 can be used to move the accumulator chain 1910. In FIG. 19B, the zoomed view of the hanging device 135 and accumulator chain 1910 illustrate how the hanging device 135 is moved along the length of the accumulator beam 1900. In this embodiment, the vacant hanging device 135 does not use the eye piece holder 240. Therefore, in this embodiment, the clip accumulator conveyor 160 moves the vacant hanging devices 135 along by engaging a chain link 230 of the clip accumulator conveyor 160 to one side of the t-shaped portion 220 of the hanging device 135. Because the hanging device 135 are stored on the chain link 230 versus being carried by the eye holder piece 240 (not illustrated in FIG. 19B), many hanging device 135 can be stored in close proximity to one another (e.g., a hanging device may be stored on each chain link 230).

It should be noted that, as are all other exemplary embodiments described herein, the exemplary embodiments of the conveyors presented above are illustrative and not defining. Thus, one of ordinary skill in the art could utilize other conveyors or systems to implement the methods described herein without deviating from the scope and spirit of the inventive system 100.

Certain steps in the process described below must naturally precede others for the invention to function as described. However, the invention is not limited to the order of the steps described if such order or sequence does not alter the functionality of the invention. That is, it is recognized that some steps may be performed before or after or in parallel with other steps without departing from the scope and spirit of the invention.

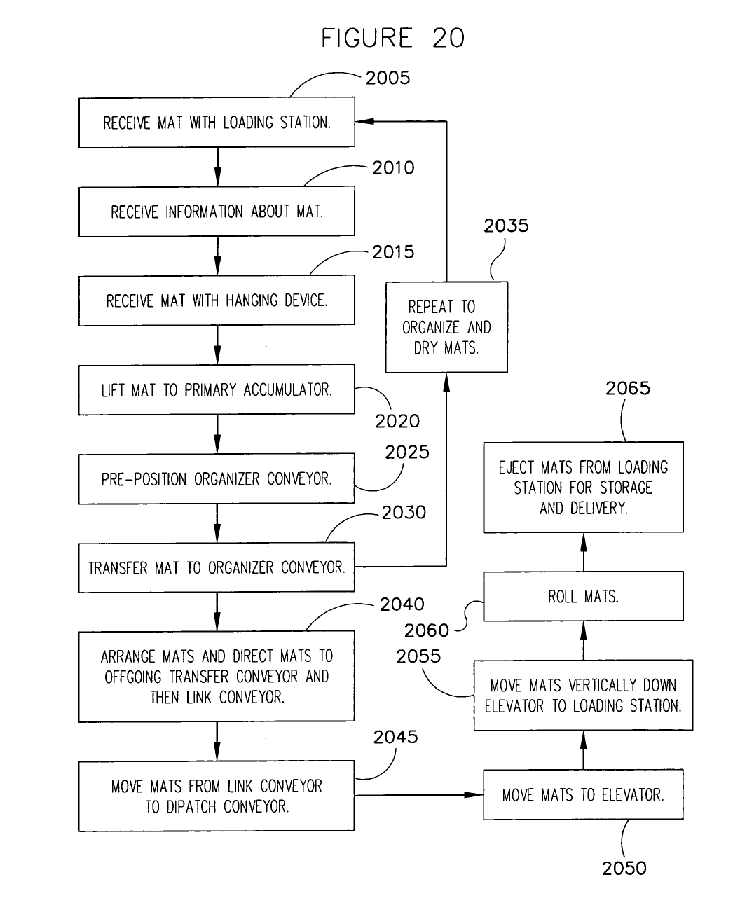

FIG. 20 is a flow chart illustrating a system and method for drying, handling, organizing and storing floor mats according to an exemplary embodiment of the inventive system. As can be seen from the flow chart, the mat 125 is inserted into the loading station 130 in step 2005. Next, in step 2010, the identification device 120 on the mat 125 may transmit data to the antenna 115 or, alternatively, the antenna 115 may read information directly from the identification device 120. This data is then transmitted to the control center 110, which can be coupled to the antenna 115 by a wire or other communication means (not illustrated). The control center 110 may record that the mat 125 has been added to the system (i.e., the control center may update its dynamic mat inventory).

While the control center 110 receives information concerning the mat 125, the loading station 130 attaches the mat 125 to the hanging device 135 by utilizing the clamping portions 210A-B and the clamping mechanisms 205A-B in step 2015. Once the mat 125 is attached to the hanging device 135, the elevator 140 lifts the mat vertically and places it onto the primary accumulator conveyor 145 in step 2020. The primary accumulator conveyor 145, in turn, moves the mat 135 to the initial transfer conveyor 155.

Next, in step 2025, the control center 110 positions the organizer conveyor 165 to accept the mat 125. This step 2025 may be performed by utilizing the information extracted from the identification device 120. For example, if the identification device 120 on the mat 125 designates the mat as part of first customer group positioned in a first section 103A (see FIG. 1), the control center 110 will move the organizer conveyor 165 around so that first customer group mats are located at the end of initial transfer conveyor 155. Once the organizer conveyor 165 is pre-positioned, the mat 125 is moved along the length of the initial transfer conveyor 155 and onto the organizer conveyor 165 in step 2030. In this way, when the initial transfer conveyor 155 moves a mat 125 that is associated with the first customer group mats, it will be properly organized alongside other first customer group mats. From this point, the process may repeat in step 2035 and more mats 125 may be placed on the organizer conveyor 165 according to the above exemplary process.

Additionally, the organizer conveyor 165 can move the mats around in a carousel or circuit fashion so that certain sets or groups of mats 125 can be moved off for storage or shipment. In this way, the inventive system 100 is able to efficiently and economically store, organize and access mats 125 needed for shipment or further storage. For example, if a certain group of mats are selected for shipment, the control center 110 can identify the mats 125 to be moved by utilizing the antenna 115 in combination with the identification devices 120 on the mats 125. The control center 110 may then direct the organizer conveyor 165 to move the mats 125 around the carousel so that the mats to be shipped can be placed on the off-going transfer conveyor 170 in step 2040. Thus, if the first customer group mats 125 are needed for shipment, the control center 110 could move organizer conveyor 165 so that those mats would exit the off-going conveyor 170.

Once the appropriate mats 125 are on the off-going transfer conveyor 170, they are moved onto the link conveyor 175. At this point, all mats 125 can be grouped and inspected for shipment. The mats 125 can then be placed on the dispatch conveyor 180 in step 2045. The dispatch conveyor 180 moves the mats 125 to the elevator 140 in step 2050. From this point, in step 2055, the mats 125 being shipped or stored are moved to the elevator 140 to be lowered vertically down to the loading station 130. Once at the loading station 130, information may be gathered from the mat 125 via the identification device 120 so that the control center 110 may update its dynamic mat inventory (i.e., the control center 110 may record that the mat is being moved out of the system 100).

When the mat 125 reaches the loading station 130, the mat rolling shaft 365 engages the mat 125 and begins to roll it. When the hanging device 135 reaches the bottom of the elevator 140, it releases the mat 125 so that the mat rolling shaft 365 may fully roll the mat 125 in step 2060. Once the mat 125 is rolled, the mat ejector 350 pushes the mat 125 out of the loading station 130 so that it may be stored or shipped in step 2065.

Many other modifications, features and embodiments of the inventive system will become evident to one of ordinary skill in the art. It should be appreciated, therefore, that many aspects of the invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. A system for handling and organizing planar objects, comprising:
a loading station that receives a planar object;
a hanging device for receiving said planar object from said loading station;
an elevator for receiving and elevating said hanging device;
a conveyor that receives said hanging device; and
a control center for positioning said planar object at a pre-determined location on said conveyor.

2. The system for handling and organizing planar objects according to claim 1, further comprising an identification device, wherein said identification device is attached to said mat.

3. The system for handling and organizing planar objects according to claim 1, further comprising a primary accumulator conveyor, wherein said mat is transferred from said elevator to said primary accumulator conveyor.

4. The system for handling and organizing planar objects according to claim 1, further comprising an off-going transfer conveyor, wherein said off-going transfer conveyor is connected to said organizer conveyor.

5. The system for handling and organizing planar objects according to claim 4, further comprising a link conveyor, wherein said link conveyor is attached to said off-going transfer conveyor.

6. The system for handling and organizing planar objects according to claim 5, further comprising a dispatch conveyor, wherein said dispatch conveyor is attached to said link conveyor and said elevator.

7. The system for handling and organizing planar objects according to claim 1, wherein said hanging device comprises a t-shaped clamping device.

8. The system for handling and organizing planar objects according to claim 7, further comprising:
a first clamping portion with a first and second end;
a second clamping portion with a first and second end;
a hinge for connecting said first and second clamping portions;
a first clamping mechanism attached to first ends of said first and said second clamping portions; and
a second clamping mechanism attached to second ends of said first and said second clamping portions.

9. The system for handling and organizing planar objects according to claim 1, further comprising a tag reading device for communicating with said control center.

10. The system for handling and organizing planar objects according to claim 9, wherein said tag reading device comprises an RFID reader.

11. A method for handling and organizing planar objects, comprising the steps of:
receiving at least one mat with a loading station;
receiving information about said mat;
receiving said mat with a hanging device;
lifting said mat to a primary accumulator conveyor;
pre-positioning an organizer conveyor; and
transferring said mat to said organizer conveyor.

12. The method for handling and organizing planar objects according to the method of claim 11, further comprising the steps of arranging said mat and directing said mats to an off-going transfer conveyor.

13. The method for handling and organizing planar objects according to the method of claim 11, further comprising the step of receiving said mat with a link conveyor.

14. The method for handling and organizing planar objects according to the method of claim 11, further comprising the step of receiving said mat with a dispatch conveyor.

15. The method for handling and organizing planar objects according to the method of claim 11, further comprising the step of lowering said mat to a loading station.

16. The method for handling and organizing planar objects according to the method of claim 11, further comprising the step of rolling said mat into a cylindrical shape.

17. The method for handling and organizing planar objects according to the method of claim 11, further comprising the step of ejecting the mat from a loading station.
